(19) United States
(12) Patent Application Publication
(10) Pub. No.: US 2009/0067098 A1
(43) Pub. Date: Mar. 12, 2009

(54) PERPENDICULAR MAGNETIC RECORDING HEAD AND METHOD OF MANUFACTURING THE SAME

(75) Inventors: Eun-sik KIM, Seoul (KR); Kook-hyun SUNWOO, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/053,720

(22) Filed: Mar. 24, 2008

(30) Foreign Application Priority Data
Sep. 12, 2007 (KR) 10-2007-0092653

(51) Int. Cl. G11B 5/33

(52) U.S. Cl. 360/313

(57) ABSTRACT

A perpendicular magnetic recording (PMR) head and a method of manufacturing the same are provided. The PMR head includes: a main pole; a coil enclosing the main pole as a solenoid type to allow the main pole to generate a magnetic field required for recording data on a recording medium; and a return yoke forming a magnetic path of a magnetic field together with the main pole and having a throat disposed opposite the main pole with a gap between the return yoke and the main pole. One end of the gap disposed near an air bearing surface (ABS) is thinner than the other end of the gap, such that the throat tapers from the other end of the gap to the one end of the gap.

### CROSS-REFERENCE TO RELATED PATENT APPLICATION

This application claims priority from Korean Patent Application No. 10-2007-0092653, filed on Sep. 12, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to a perpendicular magnetic recording (PMR) head and a method of manufacturing the same and, more particularly, to a PMR head in which a yoke length is greatly reduced to improve high frequency recording characteristics.

2. Description of the Related Art

Magnetic recording methods may be largely divided into a longitudinal magnetic recording method and a perpendicular magnetic recording method. In the longitudinal magnetic recording method, data is recorded by magnetizing a magnetic layer to be parallel to the surface of the magnetic layer, while in the PMR method, data is recorded by magnetizing a magnetic layer to be perpendicular to the surface of the magnetic layer. Since the perpendicular magnetic recording method is much superior in terms of recording density to the longitudinal magnetic recording method, laborious research has been conducted on developing various structures of PMR heads.

FIG. 1 is a cross-sectional view of a conventional perpendicular magnetic recording (PMR) head 10.

Referring to FIG. 1, the conventional PMR head 10 includes a recording head unit and a reproduction head unit. The recording head unit includes a main pole 22, a return yoke 24, a sub-yoke 28, and a coil 26. The reproduction head unit includes two magnetic shield layers 30 and a magnetoresistance (MR) device 32 interposed between the magnetic shield layers 30. The coil 26 is formed as a solenoid type to enclose the main pole 22 and the sub-yoke 28. When current is supplied to the coil 26, the main pole 22, the sub-yoke 28, and the return yoke 24 form a magnetic path of a magnetic field. A magnetic field, which travels from the main pole 22 to a recording medium (not shown), magnetizes a recording layer of the recording medium in a perpendicular direction, and returns to the return yoke 24 to write data on the recording medium. Also, the electrical resistance of the MR device 32 is changed in response to a magnetic signal generated by the magnetization of the recording layer of the recording medium, so that the data written to the recording medium can be read.

In order to increase the recording density of the conventional PMR head 10, it is necessary to improve high frequency recording characteristics of the conventional PMR head 10. The high frequency recording characteristics of the conventional PMR head 10 can be improved by maintaining a strong recording magnetic field in the high frequency range while shortening a rise time of the recording magnetic field. In order to shorten the rise time of the recording magnetic field, it is very important to reduce inductance and eddy current loss of the conventional PMR head 10.

FIG. 2 is a graph showing a rise time of a recording magnetic field according to a yoke length YL of the conventional PMR head 10 shown in FIG. 1 and a resistivity ρ of the main pole 22 shown in FIG. 1.

Referring to FIG. 2, it can be seen that the rise time of the recording magnetic field can be shortened by reducing the yoke length YL of the conventional PMR head 10, and by forming the main pole 22 using a material having a high resistivity ρ. However, the material of the main pole 22 is determined considering not only the resistivity of the main pole 22, but also the balance between the resistivity of the main pole 22 and other physical properties, such as saturation magnetization and magnetic permeability. Therefore, high frequency recording characteristics of the conventional PMR head 10 can be improved more effectively by reducing the yoke length YL. However, when simply reducing the yoke length YL to improve the high frequency recording characteristics of the conventional PMR head 10, the number of turns of the coil is also reduced to thus cause a sacrifice of a recording magnetic field. FIG. 3 is a graph showing a recording magnetic field relative to the number of turns of the coil. Referring to FIG. 3, it can be seen that as the number of turns of the coil decreases, the recording magnetic field also decreases.

### SUMMARY OF THE INVENTION

Exemplary embodiments of the present invention provide a perpendicular magnetic recording (PMR) head and a method of manufacturing the same, such that even if a yoke length and the number of turns of a coil decrease, a reduction in a recording magnetic field is minimized to increase recording density.

According to an aspect of the present invention, there is provided a PMR head including: a main pole; a coil enclosing the main pole as a solenoid type to allow the main pole to generate a magnetic field required for recording data on a recording medium; and a return yoke forming a magnetic path of a magnetic field together with the main pole and having a throat disposed opposite the main pole with a gap between the return yoke and the main pole. One end of the gap disposed near an air bearing surface (ABS) is thinner than the other end of the gap.

The gap may have a wedge-type shape.

The main pole may taper toward the ABS.

The coil may enclose the main pole once.

According to another aspect of the present invention, there is provided a method of manufacturing a PMR head comprising a main pole, a coil enclosing the main pole as a solenoid type, and a return yoke having a throat disposed opposite the main pole with a gap between the return yoke and the main pole. The method includes: sequentially forming a lower coil layer, the main pole, and a first insulating layer; forming an upper coil layer on the first insulating layer; forming a second insulating layer on the upper coil layer; etching the first and second insulating layers such that the gap tapers from the upper coil layer toward an ABS; and forming a return yoke having a throat disposed opposite the gap.

According to a still further aspect of the present invention, there is provided a perpendicular magnetic recording (PMR) head comprising a main pole, a single turn coil which surrounds the main pole, and a return yoke having a first portion disposed on the main pole and a second portion which is spaced apart from the main pole to form a gap. One end of the gap disposed near an air bearing surface (ABS) is thinner than an opposite end of the gap.

### BRIEF DESCRIPTION OF THE DRAWINGS

The above and other features and aspects of the present invention will become more apparent by describing in detail exemplary embodiments thereof with reference to the accompanying drawings, in which:

FIG. 1 is a cross-sectional view of a conventional perpendicular magnetic recording (PMR) head;

FIG. 2 is a graph showing a rise time of a recording magnetic field according to a yoke length and a resistivity of a main pole of the conventional PMR head of FIG. 1;

FIG. 3 is a graph showing a recording magnetic field relative to the number of turns of a coil;

FIG. 4 is a cross-sectional view of a PMR head according to an exemplary embodiment of the present invention;

FIG. 5 is a cross-sectional view of a PMR head according to another exemplary embodiment of the present invention;

FIG. 6 is a graph showing rise times of recording magnetic fields of the PMR head shown in FIG. 4 and a PMR head according to a comparative example;

FIG. 7 is a graph showing profiles of recording magnetic fields of the PMR heads shown in FIGS. 4 and 5 and a PMR head according to a comparative example;

FIGS. 8A through 8G are cross-sectional views illustrating a method of manufacturing a PMR head, according to an exemplary embodiment of the present invention; and

FIGS. 9A through 9E are cross-sectional views illustrating a method of manufacturing a PMR head, according to another exemplary embodiment of the present invention.

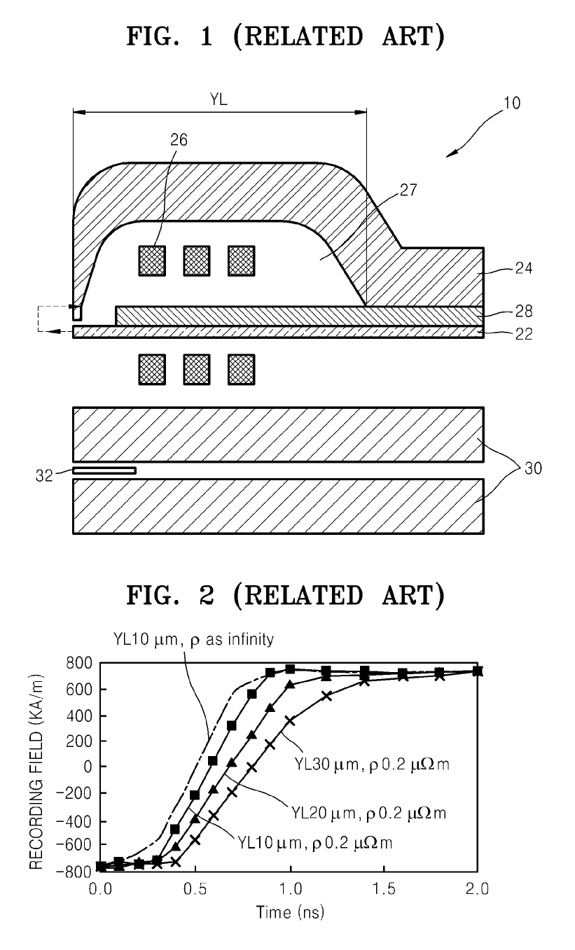

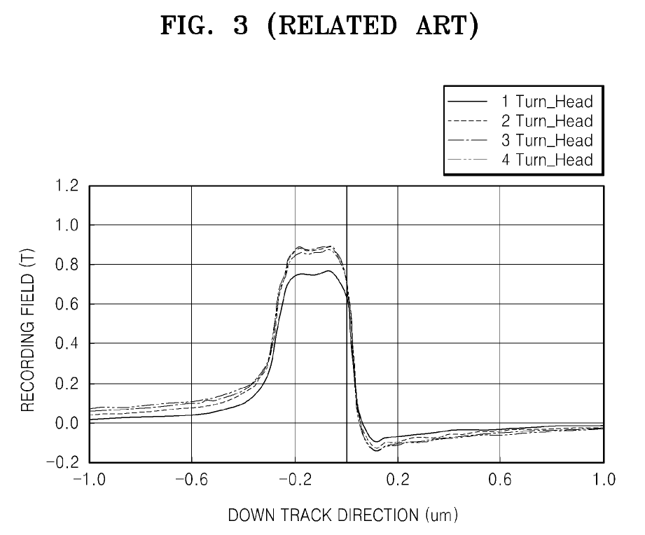

### DETAILED DESCRIPTION OF EXEMPLARY EMBODIMENTS OF THE INVENTION

The present invention will now be described more fully hereinafter with reference to the accompanying drawings, in which exemplary embodiments of the invention are shown. The same reference numerals are used to denote the same elements throughout the specification. In the drawings, the thicknesses of layers and regions are exaggerated for clarity.

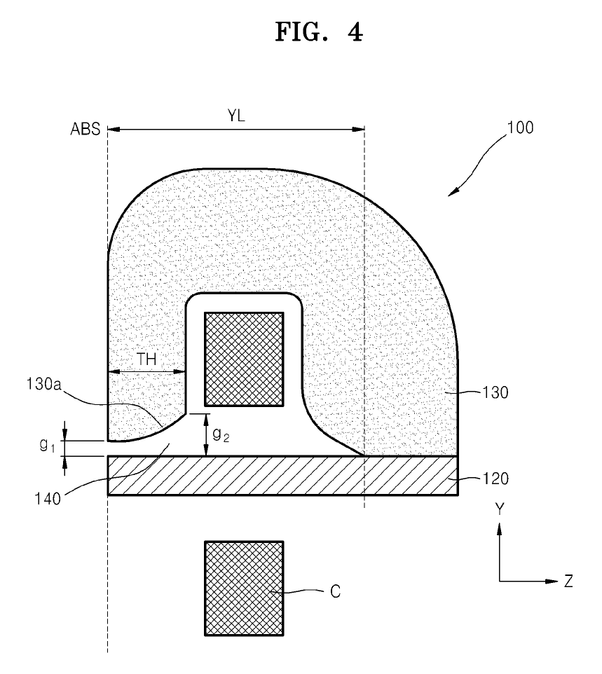

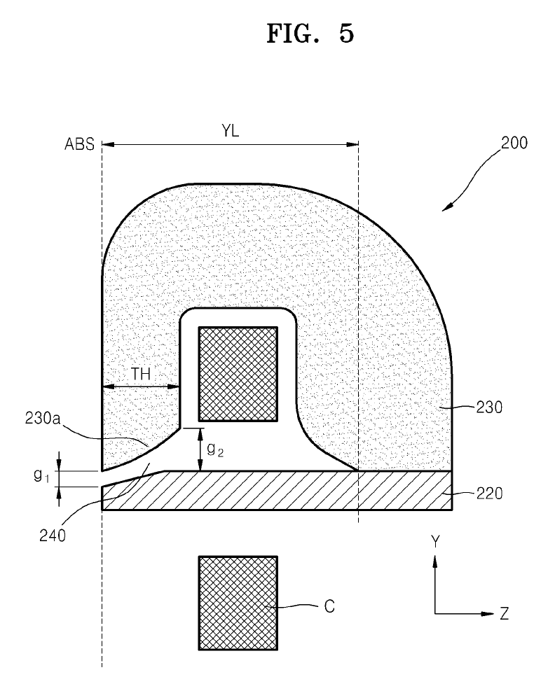

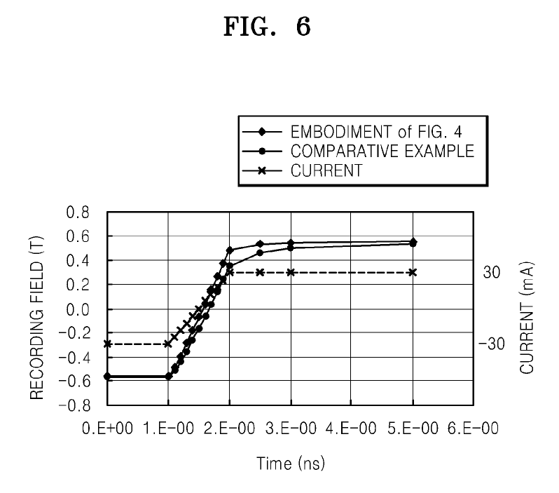

FIG. 4 is a cross-sectional view of a perpendicular magnetic recording (PMR) head 100 according to an exemplary embodiment of the present invention.

Referring to FIG. 4, the PMR head 100 includes a main pole 120, a coil C, and a return yoke 130. A current is supplied to the coil C to allow the main pole 120 to generate a recording magnetic field toward a recording medium (not shown). The return yoke 130 forms a magnetic path of a magnetic field together with the main pole 120. The PMR head 100 moves relative to a recording medium spaced a predetermined distance apart from an air bearing surface (ABS), along a down track direction (Y direction), and magnetizes the recording medium in a perpendicular direction (Z direction) by the recording magnetic field from the main pole 120 to write data on the recording medium. Typically, the PMR head 100 further includes a reproduction head (not shown) for reading the data written to the recording medium.

The main pole 120 and the return yoke 130 are formed of a magnetic material in order to form the magnetic path of the recording magnetic field generated by the coil C. In particular, the main pole 120, which is used to apply a magnetic field required to write data to the recording medium, is formed of a material having a relatively high saturation flux density Bs because the intensity of a magnetic field focused on an end tip of the main pole 120 is restricted by a saturation magnetic flux density Bs of the main pole 120. In general, the main pole 120 is formed of a magnetic material having a higher saturation magnetic flux density Bs than the return yoke 130. For example, the main pole 120 may be formed of NiFe, CoFe, or CoNiFe. The return yoke 130 may be formed to have a higher magnetic permeability than the main pole 120 so that the return yoke 130 can have a high-speed response to a change in an high frequency magnetic field. In this case, the return yoke 130 may be formed of a magnetic material, such as NiFe, and has appropriate saturation magnetic flux density Bs and magnetic permeability by controlling a content ratio of Ni to Fe.

The return yoke 130 includes a throat 130a that is disposed opposite the main pole 120 with a gap 140 between the return yoke 130 and the main pole 120. The gap 140 is prepared to form a magnetic path through which the magnetic field from the main pole 120 returns to the return yoke 130 by way of the recording medium. The gap 140 is typically filled with a nonmagnetic material, such as Al₂O₃. The gap 140 is characterized by having a front end (or an end near the ABS) with a thickness g1 smaller than a thickness g2 of a rear end of the gap 140. The thickness g1 of the front end of the gap 140 may range from about 15 to 40 nm, and the thickness g2 of the rear end of the gap 140 may range from about 100 to 200 nm. The gap 140 may have, for example, a wedge shape tapering from the rear end of the gap 140 to the front end of the gap 140. As the thickness of the gap 140 increases, the intensity of a recording magnetic field applied to the recording medium increases. However, a field gradient increases as the thickness of the gap 140 decreases. Therefore, in the present invention, both ends of the gap 140 are formed to have different thicknesses g1 and g2 so that a shunting flux of the rear end of the gap 140 is reduced to increase the recording magnetic field and the field gradient. Owing to the above-described design, a field profile can be improved under the conditions of the same magnetomotive force, thereby minimizing the number of turns of the coil. In the present invention, the coil C encloses the main pole 120 once as a solenoid type. Also, since the return yoke 130 is formed on a thin insulating layer that is disposed on the coil C to insulate the coil C from the return yoke 130, a yoke length YL is defined roughly by a throat height TH and a width of the one-turn coil C. Thus, in the present invention, the yoke length YL is minimized to about 2 μm or less.

FIG. 5 is a cross-sectional view of a PMR head 200 according to another exemplary embodiment of the present invention.

Referring to FIG. 5, the PMR head 200 includes a main pole 220, a coil C, and a return yoke 230. A current is supplied to the coil C to allow the main pole 220 to generate a recording magnetic field required to write data to a recording medium (not shown). The return yoke 230 forms a magnetic path of a magnetic field together with the main pole 220. The return yoke 230 includes a throat 230a that is disposed opposite the main pole 220 with a gap 240 between the return yoke 230 and the main pole 220. The current embodiment is generally the same as the previous embodiment except for the shape of an end of the main pole 220, which is disposed opposite the gap 240. Specifically, the end of the main pole 220 tapers toward the ABS in order to increase the effect of focusing a magnetic field on an end tip of the main pole 220 disposed near the ABS. Like in the previous embodiment, the gap 240 has a front end with a thickness g1 smaller than a thickness g2 of a rear end of the gap 240 in order to optimize the profile of the recording magnetic field. Also, the coil C encloses the main pole 220 once as a solenoid type, thereby minimizing a yoke length YL to about 2 μm or less.

In the PMR heads 100 and 200 having the above-described structures, a sufficient recording magnetic field can be applied to the recording medium using a magnetomotive force caused by only the one-turn coil C and without the use of a conventional sub-yoke for aiding a magnetic field to focus on an end tip of a main pole. Accordingly, the yoke length YL may be minimized to about 2 μm or less, and the length of the entire magnetic path can be greatly reduced, thereby enhancing high frequency recording characteristics.

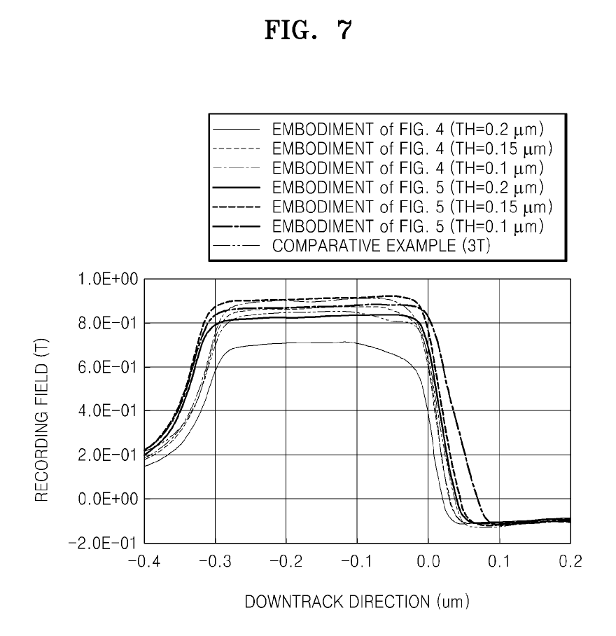

Hereinafter, the improved recording characteristics of the PMR heads 100 and 200 shown in FIGS. 4 and 5 will be described with reference to FIGS. 6 and 7 and Table 1.

FIG. 6 is a graph showing rise times of recording magnetic fields of the PMR head 100 shown in FIG. 4 in which a yoke length YL is 1.5 μm and a PMR head according to a comparative example in which a yoke length YL is 10 μm. In the PMR head according to the comparative example, a coil encloses a main pole once in order to compare the two PMR heads under the condition of the same magnetomotive force. Referring to FIG. 6, for a current rising time of 100 ps, a rise time of a magnetic field is shorter in the PMR head 100 having a shorter yoke length.

FIG. 7 is a graph showing profiles of recording magnetic fields of the PMR heads 100 and 200 shown in FIGS. 4 and 5 and a PMR head according to a comparative example. Specifically, when the PMR heads 100 and 200 had various throat heights TH, recording magnetic fields were measured in a down track direction, which is a direction in which a PMR head moves relative to a recording medium. Referring to FIGS. 4 and 5, the down track direction is the Y direction. Referring to FIG. 7, PMR heads other than the PMR head 100 having a throat height TH of 0.2 μm have almost the same magnetic field characteristics as the PMR head according to the comparative example, which has a three-turn coil and a yoke length YL of 10 μm. Considering that when the same current is supplied, the magnetomotive force of each of the PMR heads 100 and 200 according to the exemplary embodiments of the present invention is only ⅓ that of the PMR head according to the comparative example, and thus, it can be seen that the present invention is very effective in improving the magnetic field characteristics.

Table 1 shows more specific data, that is, simulation results showing recording characteristic parameters relative to current when a throat height TH is 0.1, 0.15, and 0.2 μm, respectively.

TABLE 1

| | | current | | | Gradient1 | Hw_eff | Gradient2 |
|---|---|---|---|---|---|---|---|
| | TH (um) | (mA) | Hw (T) | Hr (T) | (Oe/nm) | (T) | (Oe/nm) |
| Embodiment | 0.2 | 30 | 0.638 | −0.0928 | 264.21 | 1.018 | 416.10 |
| of FIG. 4 | | 40 | 0.714 | −0.1117 | 284.46 | 1.041 | 422.73 |
| | | 50 | 0.778 | −0.1237 | 303.39 | 1.064 | 444.38 |
| | 0.15 | 30 | 0.727 | −0.0943 | 312.22 | 1.159 | 381.91 |
| | | 40 | 0.875 | −0.1090 | 397.33 | 1.358 | 437.54 |
| | | 50 | 0.962 | −0.1221 | 428.72 | 1.422 | 473.00 |
| | 0.1 | 30 | 0.715 | −0.0967 | 304.67 | 1.141 | 372.12 |
| | | 40 | 0.910 | −0.1117 | 418.94 | 1.411 | 452.53 |
| | | 50 | 1.078 | −0.1269 | 472.52 | 1.539 | 508.30 |
| Embodiment | 0.2 | 30 | 0.730 | −0.0950 | 259.83 | 1.139 | 318.12 |
| of FIG. 5 | | 40 | 0.838 | −0.1100 | 336.09 | 1.335 | 377.81 |
| | | 50 | 0.898 | −0.1205 | 371.83 | 1.435 | 417.54 |
| | 0.15 | 30 | 0.723 | −0.1002 | 279.82 | 1.107 | 279.82 |
| | | 40 | 0.922 | −0.1154 | 317.94 | 1.434 | 360.77 |
| | | 50 | 1.025 | −0.1280 | 360.37 | 1.570 | 410.38 |
| | 0.1 | 30 | 0.695 | −0.1035 | 136.33 | 1.017 | 199.31 |
| | | 40 | 0.882 | −0.1186 | 174.13 | 1.303 | 258.49 |
| | | 50 | 0.901 | −0.1203 | 368.12 | 1.432 | 412.65 |
| Comparative | 0.2 | 30 | 0.850 | −0.1286 | 326.99 | 1.366 | 391.54 |
| example(3T) | | 40 | 0.862 | −0.1446 | 344.60 | 1.399 | 380.86 |
| | | 50 | 0.852 | −0.1719 | 365.16 | 1.424 | 419.58 |

In Table 1, Hw denotes a recording field, Hr denotes a return field, and Hw_eff denotes an effective recording field. The recording field Hw is a maximum value measured in the recording field profile and should be sufficiently high to enable recording of data to the recording medium. The return field Hr is generated in an opposite direction to a direction in which data is to be written in the recording field profile. Thus, high recording field Hw and low absolute value of return field Hr provide an advantageous condition for recording. In the table 1, the recording field Hw and the return field Hr are perpendicular components, and the effective recording field Hw_eff includes a longitudinal component as well as a perpendicular component considering that longitudinal component also contributes to perpendicular recording. When a z direction is a perpendicular direction, the effective recording field Hw_eff is defined by Equation 1:

H_{w}_{_{—}}_{eff}=((Hₓ²+H_{y}²)^{1/3}+H_{z}^{2/3})^{3/2} (1)

A field gradient affects a signal-to-noise ratio (SNR) and is represented by Gradient 1 and Gradient 2 in Table 1, and Gradient 1 and Gradient 2 denote a field gradient measured at a position where a recording field is 8000 Oe, which corresponds to the coercive force of the recording medium, and the maximum field gradient, respectively.

Referring to Table 1, in all cases according to the exemplary embodiments of FIGS. 4 and 5 except for a case where the throat height TH is 0.2 μm, the recording field is greater and the absolute value of return field is smaller than in the comparative example, and the field gradient is improved. Also, considering that the PMR head according to the comparative example has a three-turn coil and 3 times the magnetomotive force of each of the PMR heads 100 and 200 according to the exemplary embodiments of the present invention, it can be seen that the recording field characteristics of the PMR heads 100 and 200 are greatly improved.

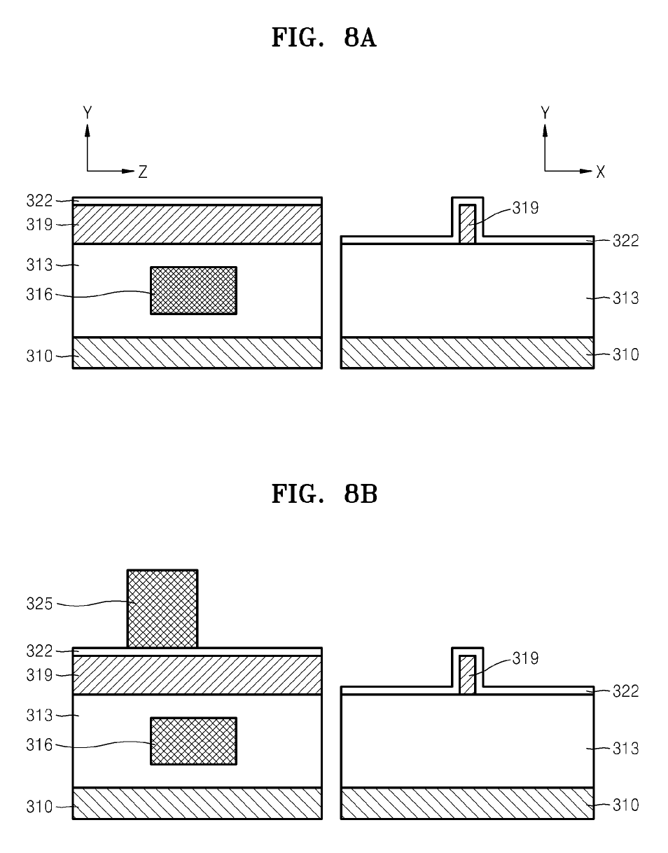

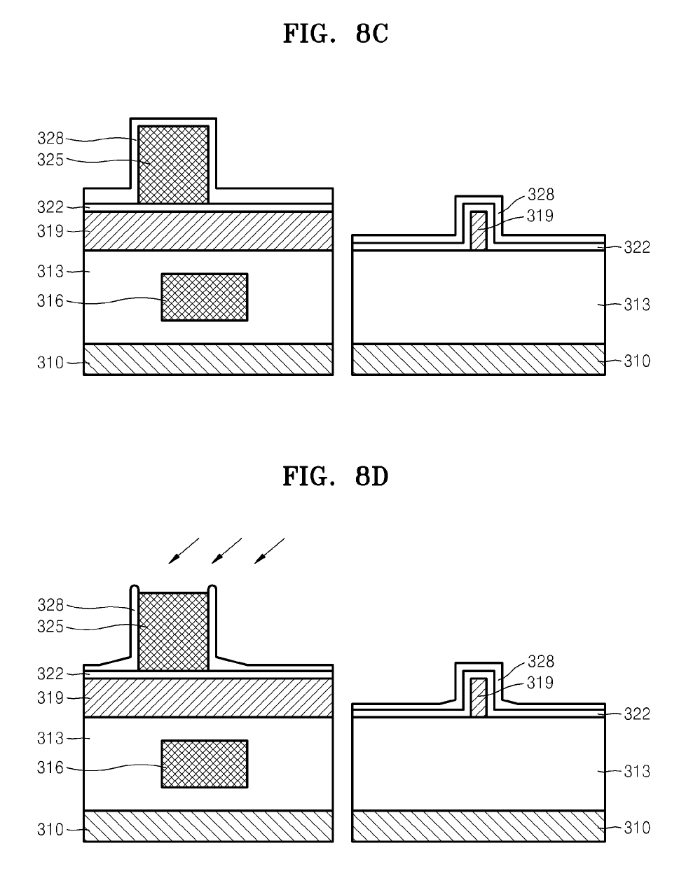

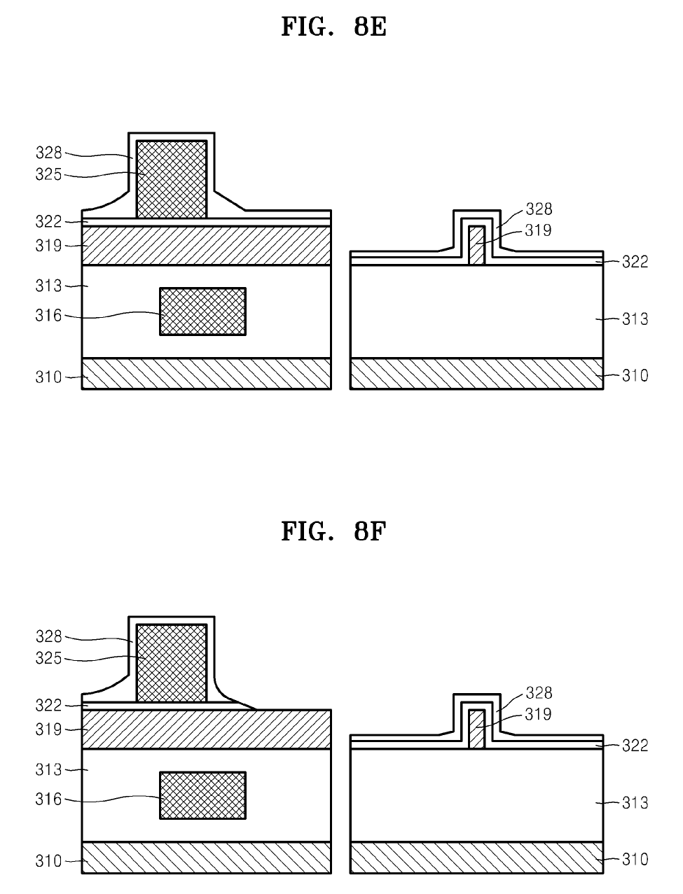

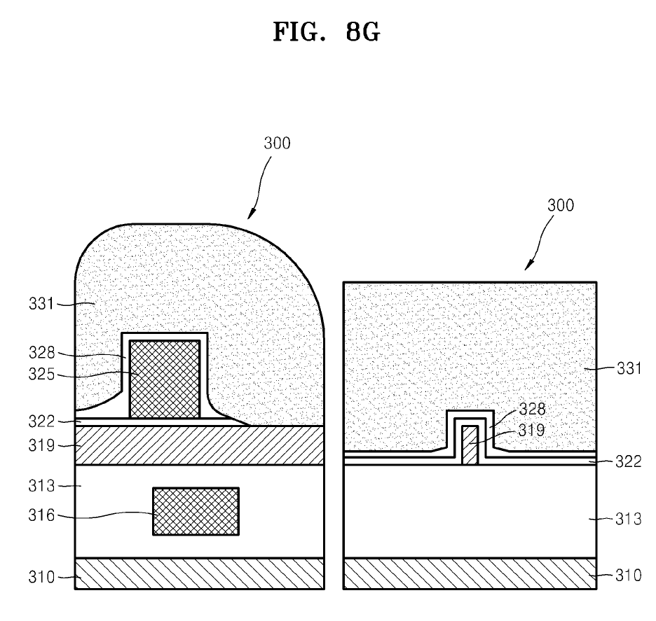

FIGS. 8A through 8G are cross-sectional views illustrating a method of manufacturing a PMR head 300 according to an exemplary embodiment of the present invention. In each of FIGS. 8A through 8G, a left cross-sectional view is taken along a Y-Z plane, and a right cross-sectional view is taken along an ABS. Also, a Y direction corresponds to a down track direction during driving of the PMR head 300 (see FIG. 8G).

Referring to FIG. 8A, an insulating layer 313, a lower coil layer 316, a main pole 319, and a first insulating layer 322 are formed on a magnetic shield layer 310. Initially, a portion of the insulating layer 313 is formed on the magnetic shield layer 310. A seed layer is formed for plating, a photolithography process and a plating process are performed, thereby forming the lower coil layer 316 and then a portion of the insulating layer 313 covering the lower coil layer 316 is formed. Although not shown in the drawings, a reproduction head including a magnetoresistance (MR) device is typically formed under the magnetic shield layer 310. The main pole 319 is formed by depositing a magnetic material having a high saturation magnetic flux density Bs, such as CoFe and CoNiFe, on the insulating layer 313 or by plating the insulating layer 313 with the magnetic material. Thereafter, the first insulating layer 322 is formed on the main pole 319. The first insulating layer 322 is provided to insulate the main pole 319 from a return yoke to be formed on the main pole 319, and the first insulating layer 322 is formed by depositing Al₂O₃ using an atomic layer deposition (ALD) method.

Referring to FIG. 8B, an upper coil layer 325 is formed on the first insulating layer 322, such that the upper coil layer 325 is combined with the lower coil layer 316 by a connection portion (not shown) to form a coil that encloses the main pole 319 as a solenoid type. In the present invention, the coil encloses the main pole 319 once (i.e., one turn) in order to minimize a yoke length YL.

Referring to FIGS. 8C and 8D, a wedge-shaped gap is formed. In detail, referring to FIG. 8C, a second insulating layer 328 is formed to cover the upper coil layer 325. For example, Al₂O₃ is deposited using an ALD technique and the second insulating layer 328 is etched . In this case, a dry etching process, such as an ion beam etching (IBE) process, may be employed. An etching profile is controlled using an ion incidence angle such that the sum of the thicknesses of the first and second insulating layers 322 and 328, which are left after the etching process, is smaller near the ABS. A gap is defined by the shapes of the portions of the first and second insulating layers 322 and 328, which are disposed on the left of the upper coil layer 325.

Referring to FIG. 8E, an insulating material is deposited again on the upper coil layer 325, so as to cover a portion of the upper coil layer 325 exposed by the etching process. For example, Al₂O₃ is deposited using an ALD technique. In this case, the insulating material is deposited to such a minimum thickness as to cover the portion of the upper coil layer 325 exposed by the etching process.

Referring to FIG. 8F, a connection portion is formed to connect the main pole 319 with a return yoke that will be formed later. Specifically, portions of the first and second insulating layers 322 and 328, which are formed at the top surface of a rear end of the main pole 319 or opposite to the ABS, are etched to expose the main pole 319.

Referring to FIG. 8G, a return yoke 331 is formed by depositing a magnetic material, such as NiFe or CoNiFe, or plating the second insulating layer 328 with such magnetic material. Although the return yoke 331 is formed as a wrap-around type to enclose an end tip of the main pole 319 as shown in the right side of FIG. 8G, it is also possible that the return yoke 331 may be formed only on the main pole 319. In the above-described process, the PMR head 300 in which a front end of a gap disposed near the ABS is thinner than a rear end of the gap and the yoke length YL is minimized can be manufactured.

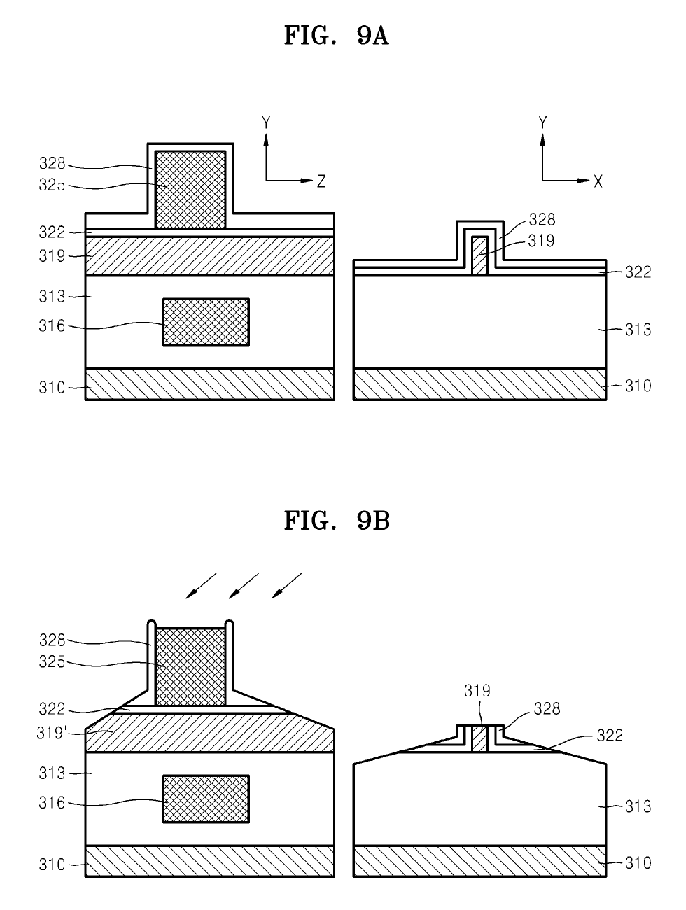

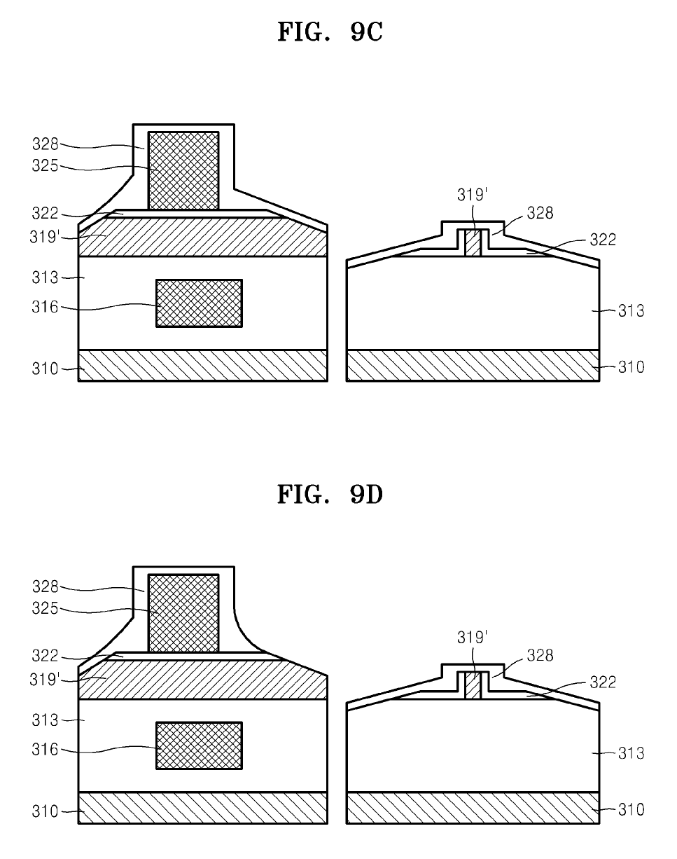

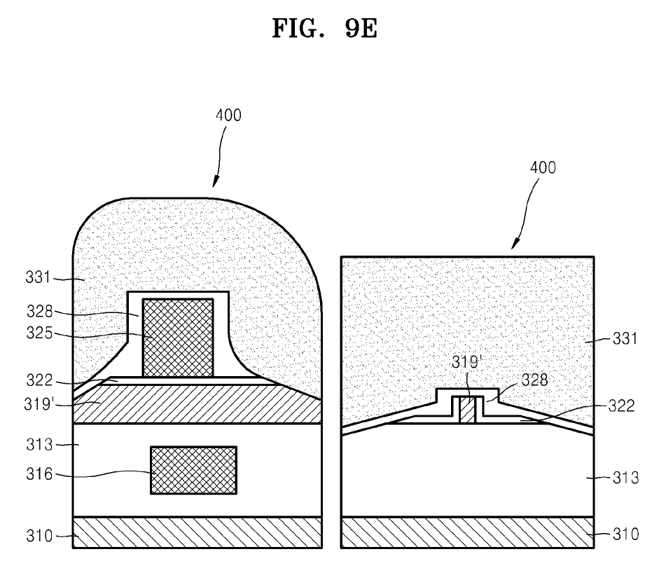

FIGS. 9A through 9E are cross-sectional views illustrating a method of manufacturing a PMR head 400 according to another exemplary embodiment of the present invention. In each of FIGS. 9A through 9E, a left cross-sectional view is taken along a Y-Z plane, and a right cross-sectional view is taken along an ABS. Also, a Y direction corresponds to a down track direction during driving of the PMR head 400 (see FIG. 9E). The current embodiment is characterized by forming a main pole 319 to have a thickness that tapers toward the ABS.

Referring to FIG. 9A, a lower coil layer 316, the main pole 319, a first insulating layer 322, an upper coil layer 325, and a second insulating layer 328 are formed in the same manner as described above with reference to FIGS. 8A through 8C.

Referring to FIG. 9B, a wedge-type gap is formed, and a main pole 319′ having a wedge-type end tip is also formed. In this case, a dry etching process, such as an IBE process, may be employed. An etching profile is controlled using an ion incidence angle such that the insulating layers 322 and 328 and the main pole 319′ taper toward the ABS.

Referring to FIG. 9C, an insulating material is deposited to cover a portion of the upper coil layer 325 and the end tip of the main pole 319′, which are exposed by the etching process. In this case, Al₂O₃ is deposited using an ALD technique. A gap is defined by the shapes of the portions of the first and second insulating layers 322 and 328 disposed on the left of the upper coil layer 325.

Referring to FIG. 9D, an etching method is performed to expose a top surface of a rear end of the main pole 319′.

Referring to FIG. 9E, a return yoke 331 is formed. In the above-described process, the PMR head 400 can be manufactured such that an end tip of the main pole 319′ tapers toward the ABS, a front end of the gap disposed near the ABS is thinner than a rear end of the gap, and the yoke length YL is minimized.

According to the above-described methods, a process of forming a sub-yoke is not required, and a process of shaping a tip of a return yoke separately is omitted, so that a PMR head, for magnetically recording data at high recording density, can be manufactured with a smaller number of processes than in conventional methods. Also, the above-described methods consistent with the present invention are characterized by forming a wedge-type gap and a solenoid-type one-turn coil to shorten a yoke length. Thus, the other processes are only exemplarily provided, so that the order or details thereof will be changed if necessary.

In a PMR head consistent with the present invention, even if a yoke length is shortened and the number of turns per coil is lessened, a reduction in a recording field is minimized. Thus, even if a one-turn coil is used, the PMR head consistent with the present invention can have about the same recording field characteristics as a conventional PMR head using a three-turn coil. Also, since the PMR head consistent with the present invention has a shorter yoke length than the conventional PMR head, the PMR head has good high frequency recording characteristics that are appropriate for high-density recording operation.

Furthermore, in a method of manufacturing a PMR head consistent with the present invention, a process of forming a sub-yoke is unnecessary, and a process of shaping a tip for a return yoke is omitted. Thus, the number of processes is greatly reduced to facilitate the mass production of the PMR head.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A perpendicular magnetic recording (PMR) head comprising:
a main pole;
a coil which encloses the main pole as a solenoid type to allow the main pole to generate a magnetic field required for recording data on a recording medium; and
a return yoke which forms a magnetic path of a magnetic field together with the main pole and which has a throat disposed opposite the main pole with a gap between the return yoke and the main pole,
wherein one end of the gap disposed near an air bearing surface (ABS) is thinner than the other end of the gap, such that the throat tapers from the other end of the gap to the one end of the gap.

2. The PMR head of claim 1, wherein the gap is wedge-shaped.

3. The PMR head of claim 1, wherein the main pole tapers toward the ABS.

4. The PMR head of claim 1, wherein the one end of the gap disposed near the ABS has a thickness of about 15 to 40 nm.

5. The PMR head of claim 4, wherein the other end of the gap has a thickness of about 100 to 200 nm.

6. The PMR head of claim 1, wherein the coil encloses the main pole once.

7. A method of manufacturing a perpendicular magnetic recording (PMR) head comprising a main pole, a coil enclosing the main pole as a solenoid type, and a return yoke having a throat disposed opposite the main pole with a gap between the return yoke and the main pole, the method comprising:
sequentially forming a lower coil layer, the main pole, and a first insulating layer;
forming an upper coil layer on the first insulating layer;
forming a second insulating layer on the upper coil layer;
etching the first and second insulating layers such that one end of the gap disposed near an air bearing surface (ABS) is thinner than the other end of the gap; and
forming the return yoke having the throat disposed opposite the gap.

8. The method of claim 7, wherein each of the first and second insulating layers is formed using an atomic layer deposition (ALD) technique.

9. The method of claim 7, wherein the etching of the first and second insulating layers further comprises:
etching the main pole such that the main pole tapers towards an end portion of the main pole near the ABS from the other portion of the main pole near the upper coil layer; and
depositing a third insulating layer to cover the upper coil layer and a portion of the main pole exposed by the etching process.

10. The method of claim 9, wherein the third insulating layer is formed using an ALD technique.

11. The method of claim 7, wherein the coil encloses the main pole once.

12. The method of claim 7, wherein the forming of the return yoke having the throat disposed opposite the gap comprises forming the return yoke as a wrap-around to enclose an end portion of the main pole disposed near the ABS.

13. A perpendicular magnetic recording (PMR) head comprising:
a main pole;
a single turn coil which surrounds the main pole; and
a return yoke having a first portion disposed on the main pole and a second portion which is spaced apart from the main pole to form a gap,
wherein one end of the gap disposed near an air bearing surface (ABS) is thinner than an opposite end of the gap.

14. The PMR head of claim 13, wherein the gap is wedge-shaped.

15. The PMR head of claim 13, wherein a yoke length is 2 μm or less.

16. The PMR head of claim 13, wherein the main pole is formed of a magnetic material having a higher saturation magnetic flux density than the return yoke.

17. The PMR head of claim 16, wherein the main pole is formed from a material selected from NiFe, CoFe and CoNiFe.
